(19) United States
(12) Patent Application Publication
(10) Pub. No.: US 2012/0110643 A1
(43) Pub. Date: May 3, 2012

(54) SYSTEM AND METHOD FOR TRANSPARENTLY PROVIDING ACCESS TO SECURE NETWORKS

(76) Inventors: Jeffrey C. Schmidt, Orlando, FL (US); Peter Stanforth, Winter Springs, FL (US); Donald L. Joslyn, DeBary, FL (US); Manish Shukla, Altamonte Springs, FL (US); Mario A. Camchong, Oviedo, FL (US); Sekhar V. Uppalapati, Longwood, FL (US); Hrishikesh Gossain, Heathrow, FL (US)

(21) Appl. No.: 12/916,908

(22) Filed: Nov. 1, 2010

(51) Int. Cl. H04L 9/00

(52) U.S. Cl. 726/4; 726/6

(57) ABSTRACT

Network access for a secure network is transparently provided to a wireless device using a social networking type of framework. An operator of a secure wireless network may register the network and access credentials for the network with a network access management system. The operator also may configure network access settings, such as designating a sharing level, that permits wireless devices meeting access criteria for the sharing level to use the network. Electronic devices belonging to social media contacts, such as family members and friends, may be associated with the registered network. When the associated devices or other qualifying devices are within communication range of the network, a client function in the device may coordinate with the network access management system to provide network access to the devices. The coordination may take place through a network different than the secure network, such as a cellular network to which the electronic device has subscription access. The network access may be established in a manner that is transparent to the user of the electronic device.

### TECHNICAL FIELD OF THE INVENTION

The technology of the present disclosure relates generally to electronic devices and, more particularly, to a system and method for providing network access to electronic devices using social network affiliations.

### BACKGROUND

Wireless electronic devices, especially those with a high degree of portability while in use, are becoming increasingly popular. But a challenge for these devices is providing reliable, high speed network access.

Many portable wireless electronic devices rely on cellular networks to support wireless communications and Internet access. Typically, these devices also may access the Internet and other network services, including messaging and calling, using alternative types of networks. For instance, most mobile telephones that are currently on the market have cellular communications capabilities and WiFi communications capabilities. But most WiFi networks require access credentials to establish communications with the WiFi network. Access credentials may include a user name and password, a security code (e.g., a wired equivalent privacy key or WEP key), or other certificate or authorization information.

Many operators of wireless networks would be willing to allow electronic devices operated by other persons to have temporary access their network, but may not be willing to make access credentials known to those other persons. In other situations, operators of wireless networks would be willing to allow electronic devices operated by other persons to have temporary access to their network if they know the identity of those persons or have some other established relationship with those other persons. But there is presently no convenient way to share network access under these circumstances.

### SUMMARY

To improve communications capability of portable electronic devices, the present disclosure describes systems and methods of transparently providing network access for a secure network to a wireless device using a social networking type of framework. An operator of a secure wireless network may register the network and access credentials for the network with a network access management system. The operator also may configure network access settings, such as designating a sharing level, that permits wireless devices meeting access criteria for the sharing level to use the network. Other network access settings may include priority of access, use restrictions, and so forth. Electronic devices belonging to social media contacts, such as family members and friends, may be associated with the registered network by action of the operator and/or by the social media contacts. When the associated devices and/or other qualifying devices are within communication range of the network, a client function in the device may coordinate with the network access management system to provide network access to the devices. The coordination may take place through a network different than the secure network, such as a cellular network to which the electronic device has subscription access. The network access may be established in a manner that is transparent to the user of the electronic device.

According to one aspect of the disclosure, a method of providing access to a secure network for wireless communications, the network requiring access credentials to carry out the wireless communications, includes registering the network and the access credentials for the network with a network access management system; configuring network access settings including an access permission level that includes persons designated or accepted as social network friends of an owner of the network; and securely providing the access credentials to an electronic device associated with a social network friend when the electronic device is in communication range of the network.

According to another aspect of the disclosure, a method of acquiring access to a secure network for wireless communications by an electronic device, the network requiring access credentials to carry out the wireless communications, includes establishing a social network friend status with an owner of the network as a prerequisite for receiving the access credentials for the network; detecting an access point belonging to the network; requesting network connectivity to the network from a network access management system; electronically and securely receiving the access credentials from the network access management system; connecting to the access point for carrying out wireless communications with the electronic device; and maintaining the access credentials in a secure manner by the electronic device so that a user of the electronic device is without an ability to display or ascertain the access credentials.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a schematic view of a communication system;

FIG. 2 is an exemplary process flow for configuring network access using a social networking type of framework;

FIG. 3 is a schematic view of network access permission levels within the social network framework for network access; and

FIG. 4 is an exemplary process flow carried out by an electronic device and a network access management system for establishing network access.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

In the present document, embodiments are described primarily in the context of a portable wireless radio communications device, such as a mobile telephone. For purposes of description, the device will be referred to as an electronic device. It will be appreciated, however, that the exemplary context of a mobile telephone is not the only operational environment in which aspects of the disclosed systems and methods may be used. The disclosed systems and methods may be applied to various types of portable electronic devices and/or to fixed location electronic devices, so long as the device has wireless radio communications capability. Therefore, the techniques described in this document may be applied to any type of appropriate electronic device, examples of which include a mobile telephone, a media player, a gaming device, a computer, a personal digital assistant (PDA), an electronic book reader, etc.

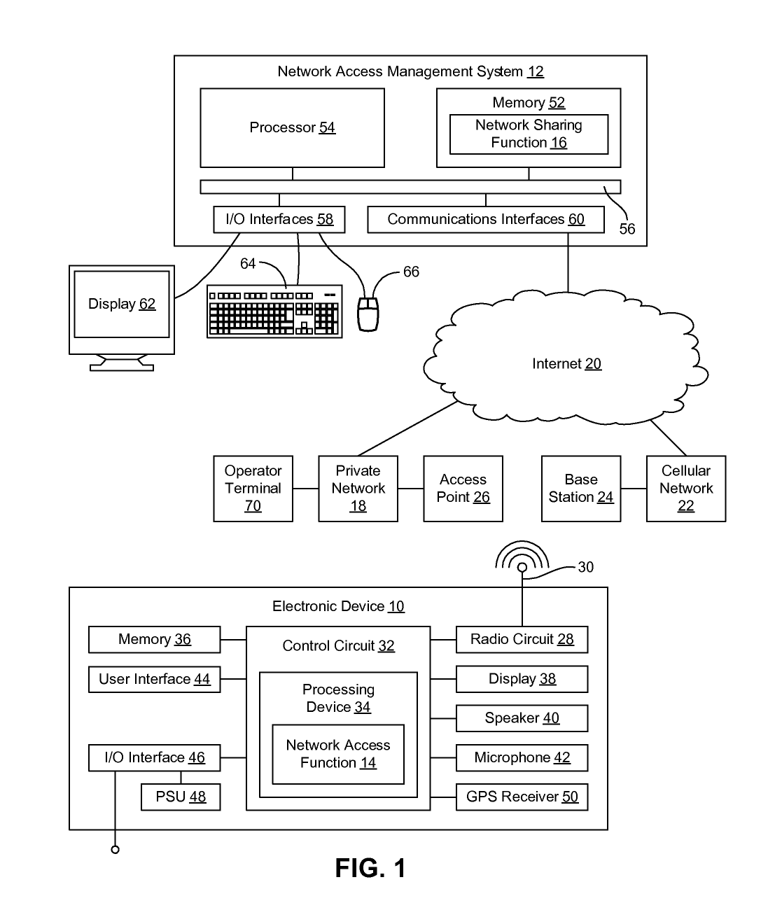

Referring initially to FIG. 1, shown is a system that includes an electronic device 10 and a network access management system 12. The electronic device 10 is portable and has wireless communication capabilities, as will be described in greater detail below. The network access management system 12 may be configured as a server that communicates with the electronic device 10 and other devices, as will also be described. The electronic device 10 may include a network access function 14 and the network access management system 12 may include a network sharing function 16. The network access function 14 and the network sharing function 16 may cooperate with each other to assist the electronic device 10 access a private network 18 that is operated and/or owned by a party that is different than the party that operates and/or owns the electronic device 10.

In the exemplary context of a mobile telephone, the electronic device 10 may access the Internet 20 and carry out other communications functions, such as engaging in voice or video calls, and sending or receiving messages (e.g., email messages, text messages, multimedia messages, instant messages, etc.) through a subscription service. In a typical arrangement, the subscription service provides access to a cellular network 22 through a base station 24 that services the geographic location of the electronic device 10. It will be appreciated that the cellular network 22 may have a multitude of base stations 24 to service a wide geographic area.

From time to time, the electronic device 10 may become located within communication range of the private network 18. It may be advantageous for the electronic device 10 to access the Internet 20 through the private network 18 and/or carry out other communication tasks (e.g., engage in calls and/or messaging) through the private network 18. If the private network 18 is unsecure, the electronic device 10 may be able to connect with the private network 18 through an associated access point 26. But in most cases, the private network 18 will require login or security credentials to establish communications between the electronic device 10 and the private network 18. As will be described, the following techniques may facilitate access to the network 18 by the electronic device 10.

It will be appreciated that the network 18 may be associated with more than one access point 26. It will be further appreciated that the network 18 may be operated by an individual or an entity. In some embodiments, the network 18 may cover a single geographic area and, in other embodiments, the network 18 may cover plural, discontinuous geographic areas. The network 18 may be, for example, a wireless network established in a person's home or residence using a single wireless router as an access point 26. As another example, an entity, such as a business or school, may deploy the network 18 using one or more access points 26 to cover a desired geographic area. In another example, an entity may operate from multiple locations. For instance, a chain of coffee shops, fast food restaurants or stores may have multiple locations. In each location, the entity may operate wireless communications services for customers. For purposes of description, this type of geographically non-contiguous communications arrangement will be referred to as the network 18 with one or more access points 26, regardless of the actual network topology used to implement the wireless communications services at each location.

Also, for purposes of description, the network 18 may be a WiFi network (e.g., a network operating in accordance with IEEE 802.11). But the network 18 need not be a WiFi network. Other exemplary types of networks include, but are not limited to, a WiMAX network (e.g., a network operating in accordance with IEEE 802.16), an enhanced data rates for global system for mobile communications (GSM) evolution (EDGE) network, a wideband code division multiple access (WCDMA) network, etc.

Each of the network access function 14 and the network sharing function 16 may be embodied as a set of executable instructions (e.g., referred to in the art as code, programs, or software) that are respectively resident in and executed by the electronic device 10 and the network access management system 12. The functions 14 and 16 each may be one or more programs that are stored on respective non-transitory computer readable mediums, such as one or more memory devices (e.g., an electronic memory, a magnetic memory, or an optical memory). In the following description, ordered logical flows for the functionality of the connectivity function 14 and the network access function 16 are described. But it will be appreciated that the logical progression may be implemented in an object-oriented or a state-driven manner. Also, some or all of the functions that are described as being carried out by the electronic device 10 or the network access management system 12 may be carried out by a different device, such as the access point 26.

As indicated, the electronic device 10 may be configured as a multi-mode device to carry out wireless communications using plural types of connectivity options. For this purpose, the electronic device 10 may include communications circuitry in the form of a radio circuit assembly 28 and an antenna assembly 30. The radio circuit assembly 28 and the antenna assembly 30 represent circuitry to communicate over more than one type of communication interface. Therefore, the illustrated components may represent one or more than one radio transceiver, depending on capabilities of the implementing hardware to tune to multiple frequencies and carry out communications using multiple protocols.

The electronic device 10 may be configured for interaction with a mobile telephone network in the form of the cellular communications network 22. Exemplary cellular communications networks include, by are not limited to, networks operating in accordance with GSM, EDGE, WCDMA, integrated services digital broadcasting (ISDB), high speed packet access (HSPA), or any other appropriate standard or advanced versions of these standards. The cellular communications networks may be compatible with 3G and/or 4G protocols. Additionally, the electronic device 10 also may be configured to communicate with other types of networks, such as a packet-switched network. An exemplary packet-switched network includes a network configured in accordance with IEEE 802.11 (e.g., IEEE 802.11a, IEEE 802.11b, or IEEE 802.11n), each of which are commonly referred to as WiFi. Another exemplary packet-switched network includes a network configured in accordance with IEEE 802.16 (commonly referred to as WiMAX).

Overall functionality of the electronic device 10 may be controlled by a control circuit 32 that includes a processing device 34. The processing device 34 may execute code stored in a memory (not shown) within the control circuit 32 and/or in a separate memory 36 in order to carry out the operations of the electronic device 10. For instance, the processing device 34 may be used to execute the network access function 14. The memory 36 may be, for example, one or more of a buffer, a flash memory, a hard drive, a removable media, a volatile memory, a non-volatile memory, a random access memory (RAM), or other suitable device. In a typical arrangement, the memory 36 may include a non-volatile memory for long term data storage and a volatile memory that functions as system memory for the control circuit 32. The memory 36 may exchange data with the control circuit 32 over a data bus. Accompanying control lines and an address bus between the memory 36 and the control circuit 32 also may be present.

Another component of the electronic device 10 may be a display 38 that is used to display visual information to a user. The electronic device 10 may include a speaker 40 and a microphone 42 to allow the user to carry out voice conversations. A user interface 44, such as a keypad and/or a touch screen associated with the display 38, may be present to provide for a variety of user input operations.

The electronic device 10 may further include one or more input/output (I/O) interface(s) 46. The I/O interface(s) 46 may include one or more electrical connectors for connecting the electronic device 10 to another device (e.g., a computer) or an accessory (e.g., a personal handsfree (PHF) device) via a cable, and/or for connecting the electronic device 10 to a power supply. Therefore, operating power may be received over the I/O interface(s) 46 and power to charge a battery of a power supply unit (PSU) 48 within the electronic device 10 may be received over the I/O interface(s) 46. The PSU 48 may supply power to operate the electronic device 10 in the absence of an external power source.

The electronic device 10 also may include various other components. For instance, a camera (not shown) may be present for taking digital pictures and/or movies. Image and/or video files corresponding to the pictures and/or movies may be stored in the memory 36. A position data receiver, such as a global positioning system (GPS) receiver 50, may be involved in determining the location of the electronic device 10.

The network access management system 12 may be implemented as a computer-based system that is capable of executing computer applications (e.g., software programs), including the network sharing function 16. The network sharing function 16, and an affiliated network information database, may be stored on a non-transitory computer readable medium, such as a memory 52. The memory 52 may be a magnetic, optical or electronic storage device (e.g., hard disk, optical disk, flash memory, etc.), and may comprise several devices, including volatile and non-volatile memory components. Accordingly, the memory 52 may include, for example, random access memory (RAM) for acting as system memory, read-only memory (ROM), hard disks, optical disks (e.g., CDs and DVDs), tapes, flash devices and/or other memory components, plus associated drives, players and/or readers for the memory devices. To execute the network sharing function 16, the network access management system 12 may include one or more processors 54 used to execute instructions that carry out logic routines. The processor 54 and the components of the memory 52 may be coupled using a local interface 56. The local interface 56 may be, for example, a data bus with accompanying control bus, a network, or other subsystem.

The network access management system 12 may have various video and input/output (I/O) interfaces 58 as well as one or more communications interfaces 60. The interfaces 58 may be used to operatively couple the network access management system 12 to various peripherals, such as a display 62, a keyboard 64, a mouse 66, etc. The communications interface 60 may include for example, a modem and/or a network interface card. The communications interface 60 may enable the network access management system 12 to send and receive data signals, voice signals, video signals, and the like to and from other computing devices via an external network. In particular, the communications interface 60 may connect the network access management system 12 to the Internet 20.

Systems and methods of providing the electronic device 10 with access to the private network 18 will be described in detail. The techniques may be implemented in a manner that is independent of network subscriptions or service plans of the electronic device 10 and independent of predetermined or current network association of the electronic device 10.

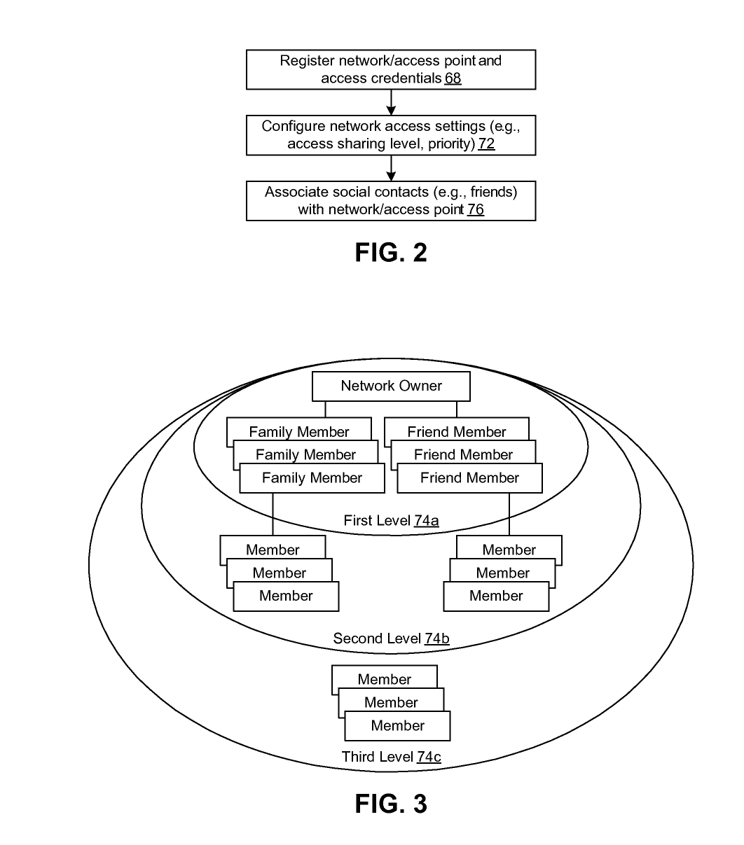

With additional reference to FIG. 2, illustrated are logical operations to implement an exemplary method of registering and configuring sharing conditions as part of availing the network 18 for use by others for wireless communications. Portions of the illustrated exemplary method may be carried out by executing the network sharing function 16, for example. Thus, the flow chart of FIG. 2 may be thought of as depicting steps of a method carried out by the network access management system 12. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may begin block 68 where the network 18 is registered with the network access management system 12. Registration of the network 18, as well as other network sharing configuration settings, may be made by an operator of the network 18 using an operator terminal 70 (FIG. 1). The operator terminal 70 may be any suitable computing system (e.g., a computer or a smart-phone) that is capable of establishing communication with the network access management system 12. In one embodiment, the network access management system 12 may function as a server that hosts an Internet-based website through which the operator of the network 18 may carry out registration configuration steps using an Internet browser executed by the operator terminal 70.

In one embodiment, the entire network 18, inclusive of all access points 26 in the network 18, may be registered with the network access management system 12 for sharing by electronic devices 10 that meet sharing criteria as described in greater detail below. In other embodiments, and where the network 18 includes plural access points 26, one or more specific access points 26 may be registered for sharing while other access points 26 in the network 18 may be excluded from sharing.

Also, in block 68, access credentials for use by qualifying electronic devices 10 to access the network 18 may be registered with the network access management system 12. The access credentials may take any appropriate form, such as a user name and password, a WEP key, or some other login data, digital certificate, encryption key, or security credential.

In block 72, network access settings may be configured. Network access settings may include a network access permission level. In one embodiment, the operator of the network 18 may select a permission level from plural permission level options. Each permission level option may have one or more member types. Assuming all other network access criteria is met by an electronic device 10, then an electronic device 10 that is associated with the selected network access permission level will be allow to carry out communications through the network 18.

With additional reference to FIG. 3, illustrated is a schematic view of exemplary network access permission levels 74 that are arranged in accordance with a computerized social network framework. Computerized social networks also may be referred to as social media. The permission levels 74 organize persons by relationship with a principle member, which may be the network owner in this context. In the illustrated exemplary arrangement of permission levels 74, there are three permission levels 74. It will be appreciated that there may be more than or less than three permission levels and/or the illustrated members of each permission level may be allocated differently among the permission levels. In one embodiment, the number of permission levels 74 and the types of members for each permission level 74 may be configured by the operator of the network 18.

In the illustrated example, members of a first permission level 74a when the network owner is an individual may include, for example, family members of the network owner and friends of the network owner. Family members are typically persons that have a familial relationship to the network owner. When the network owner is an individual, friend members typically are persons that are personally known to the network owner. This type of person may become a friend member of the first permission level 74a by being designated as a friend by the network owner. Another way that a person may become a friend member is by requesting to become a friend of the network owner and being accepted as a friend by the network owner. Another way that a person may become a friend member is by the network owner inviting a potential friend to become a friend and the potential friend accepting the invitation. These persons may be considered enrolled friends. Also, friendship may be bidirectional or unidirectional for purposes of network sharing. That is, and if applicable, friends automatically may have the same standing with respective permission levels 74 for each other's networks 18 (or bidirectional friendship). Alternatively, a network owner may not be a friend of a friend member when it comes to access permission of a network owned by that friend member (or unidirectional friendship). In still another embodiment, a person may be a friend member of the first permission level 74a if the person and the network owner are friends in a commercially available social network, such as the social network available under the designation FACEBOOK by Facebook, Inc. of Palo Alto, Calif., USA. Family members may be established in similar manner to the way friend members are established.

In a commercial setting, family members may not be applicable. Instead, members of a first permission level 74a may include, for example, employees of the network owner and friends of the network owner, or just friends of the network owner. Employee members typically would be persons that work for or have some other defined relationship with network owner. Similarly, in an academic setting, members of a first permission level 74a may include, for example, faculty and students of the corresponding institution and friends of the network owner. In these types of contexts, a person may become a friend in the same manner as when the network owner is an individual (e.g., by designation by the network owner or by submitting a request that is accepted by the network owner). In these contexts, a person also may become a friend member of the first permission level 74a by enrolling or “signing up” as a friend. For instance, in social media, a person may become a fan of a company. People will often become social media fans of a company to received news updates, coupons, or other benefits. For purposes of network access, fans of a company may be considered friend members of the first permission level 74a to receive a benefit in the form of access to the network 18 when the person visits a corresponding business establishment. These persons may be considered enrolled friends.

The exemplary second access permission level 74b includes the members of the first access permission level 74a, as well as members that are friends of family members of the first level 74a and friends of friend members of the first level 74a. In the social media framework, friends of family members and friends of the principle member friends may be referred to as acquaintances. Therefore, the second permission level 74b may be considered to have members that are acquaintances of the network owner. Persons may become friends of a network owner's family member or a network owner's friend in the same manner as a person may become a friend of the network owner for inclusion in the first permission level 74a.

In the illustrated embodiment, the third permission level 74c includes the members of the first and second access permission levels 74a and 74b, as well as people who are not family members, friend members, or acquaintances. These persons may be considered members of the general public.

It will be recognized that persons use an associated electronic device 10 to carry out wireless communications. Therefore, when registering members of a permission level 74, the persons may be registered in a manner that enables identification of the person's corresponding electronic device 10. For instance, mobile telephones may be identified by subscriber identity module (SIM) card number or by telephone number. It will be appreciated that other identification techniques may be employed. Registering the person in conjunction with or only using associated electronic device 10 information will allow the establishment of network access between the network 18 and the electronic device 10 in a manner that is transparent to the user of the electronic device 10. For instance, the electronic device 10 itself may be recognized without user input of information to identify the user.

In the exemplary arrangement of permission levels 74 that has been described and illustrated, if the network operator selects to allow network access to members of the first permission level 74a, then electronic devices 10 associated with family members (or employees in a commercial setting) and enrolled friends of the network owner will be able to access the network 18 to carry out wireless communications, provided any other access criteria is met. If the network operator selects to allow network access to members of the second permission level 74b, then electronic devices 10 associated with the first permission level 74a and acquaintances will be able to access the network 18 to carry out wireless communications, provided any other access criteria is met. If the network operator selects to allow network access to members of the third permission level 74c, then electronic devices 10 associated with members of the first permission level 74a, members of the second permission level 74b, and members of the third permission level 74c will be able to access the network 18 to carry out wireless communications, provided any other access criteria is met.

In one embodiment, the network operator may have the option to not select an access permission level 74. In this case, electronic devices 10 may not access the network 18 by virtue of being affiliated with an access permission level 74. In this case, only electronic devices 10 that independently have access credentials (e.g., a user entered username and password, or a user entered WEP key) will be able to engage in wireless communications using the network 18.

The network operator may be able to change the selected access permission level 74 at any time. The network operator may be able to change, add or delete family members and friends at any time.

Other network access settings in addition to the access permission level 74 may be configured in block 72. For example, priority settings may be made. Priority settings may be used to provide network access to some types of users over others, especially when a maximum number of users for the network 18 is reached. In one embodiment, the network operator may specify that existing users have access over new users when a user maximum is reached. In one embodiment, the network operator may specify that family members have priority over friends, and friends have priority over acquaintances, and/or acquaintances have priority over members of the general public. In one embodiment, the network operator may specify that electronic devices 10 have user entered access criteria have priority over electronic devices 10 that are eligible for network access by belonging to an access permission level 74. As will be appreciated, other priority settings may be established.

Another exemplary network access setting may be a control (e.g., a limit) regarding the types of communications activity that are allowed with the network 18. For example, the network operator may set a policy to not allow video downloads or calls to take place over the network 18. Another exemplary network access setting may be presence criteria. For example, an electronic device 10 associated with the network owner may be required to be present and in communication with the network 18 for members of the selected access permission level 74 to use the network 18. Another exemplary network access setting may be quality of service (QOS) or other service feature that may be made available to members of the selected access permission level 74.

Continuing with the logical flow of FIG. 2, following block 72 the logical flow may progress to block 76. In block 76, social contacts may be established. More specifically, the various member types in the access permission levels may be populated with identity information for each member. In some situations, the populating of the members may involve action on the part of the network operator or owner. For example, family members and friends may be specified by the network owner, or may become friends by invitation or acceptance by the network owner. In other situations, friends may become established by action of the user of an electronic device 10, such as by enrollment as a fan of a corporate entity. As will be appreciated, the operations of block 76 may be an ongoing activity as the network owner adds, modifies or removes friends and/or family members.

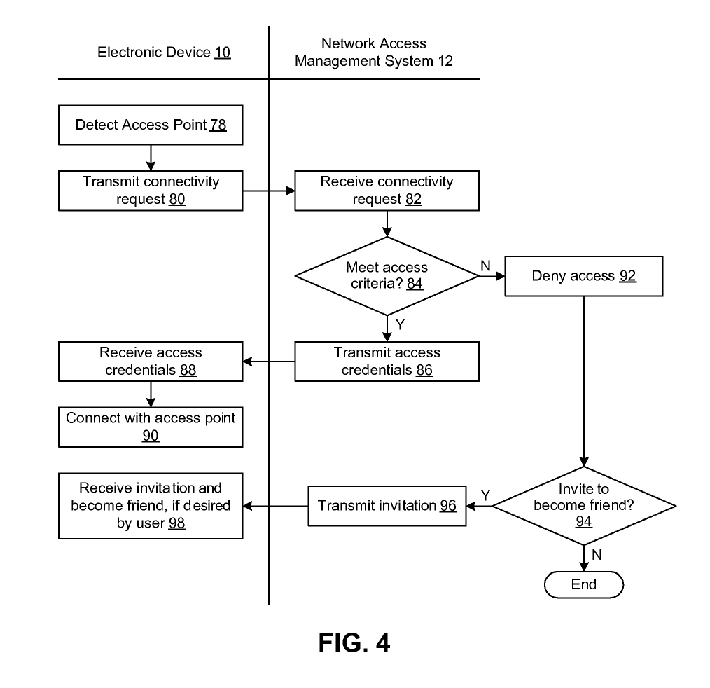

With additional reference to FIG. 4, illustrated are logical operations to implement an exemplary method of conducting wireless communications using the network 18 with an electronic device 10 that is a member of the selected access permission level 74. Portions of the illustrated exemplary method may be carried out by executing the network access function 14 and portions may be carried out by executing the network sharing function 16. Thus, the flow chart of FIG. 4 may be thought of as depicting steps of a method carried out by the electronic device 10 and as depicting steps of a method carried out by the network access management system 12. Although FIG. 2 shows a specific order of executing functional logic blocks, the order of executing the blocks may be changed relative to the order shown. Also, two or more blocks shown in succession may be executed concurrently or with partial concurrence. Certain blocks also may be omitted. Also, some steps depicted as being executed by one device may be carried out by another device. For instance, some steps, or similar validation of the electronic device 10, may be carried out by the access point 26 or elsewhere in the network 18.

The logical flow may begin in block 78 where the electronic device 10 detects the access point 26. The network access function 14 may recognize the access point 26, and/or recognize the underlying network 18, as a potential resource to carry out wireless communications. Then, in block 80, the electronic device 10 may transmit a request to the network access management system 12 for access to the network 18. The request may be received by the network access management system 12 in block 82. The request and other communications between the electronic device 10 and the network access management system 12 may be exchanged over any available communication pathway, which may include the cellular network 22. In one embodiment, the network 18 may permit electronic device 10 to communicate with the network access management system 12 through the network 18 without access credentials that would permit other communications activity.

In block 84, the network access management system 12 may determine whether the electronic device 10 meets access criteria for using the network 18 to carry out wireless communications. The determination may include determining if the electronic device 10 is a member a selected one of the access permission levels 74. The determination also may include determining if the electronic device meets any other access criteria, such as having adequate priority over other users.

If a positive determination is made in block 84, the logical flow may proceed to block 86 where the network access management system 12 transmits access credentials for the network 18 to the electronic device 10. The access credentials may be received by the electronic device in block 88. The access credentials may be transmitted to the electronic device over any available communications pathway, which may include the cellular network 22. The access credentials may be transmitted by the network access management system 12 in a secure manner (e.g., using encryption). Also, the access credentials may be handled by the electronic device 10 through the network access function 14 in a secure manner. For instance, encryption may be employed and/or data handling techniques to conceal data from the user or limit user access to the data may be employed. In this manner, the user of the electronic device 10 may not see, display or directly access the received access credentials. Therefore, the access credentials may be received and used by the electronic device 10 to interface with the access point 26 in a secure manner and without the user of the electronic device 10 having the ability to ascertain the values of the access credentials.

Next, in block 90, the electronic device 10 may connect with the access point 90 using the received access credentials, such as by establishing a network session. Once connected, the electronic device 10 may carry out wireless communications through the network 18, such as accessing the Internet, sending and receiving messages, making and receiving calls, and so forth. The establishment of the connection with the network 18 may be completely transparent to the user of the electronic device 10. For instance, the communications with the network access management system 12 and the use of the access credentials to access the network 18 may be carried out without user involvement and/or knowledge. In some embodiments, however, the user may be prompted to authorize the connection and/or may initiate the process of acquiring the access credentials.

If a negative determination is made in block 84, the logical flow may proceed to block 92 where access to the network 18 by the electronic device 10 is denied. It is possible that the user of the electronic device 10 may not learn that access to the network 18 is denied. In other embodiments, the user may be alerted to the denial and/or may be provided with an opportunity to enhance his or her membership status to become affiliated with an access permission level 74 that would allow access to the network 18. For example, if the network 18 is operated by a commercial enterprise as a way to encourage people to visit an establishment, then facilitating access to the network may be desirable to the commercial enterprise. Therefore, following block 92 and in block 94, the network access management system 12 may determine whether an invitation to become a friend member (or fan) of the first access permission level 74 should be transmitted to the electronic device 10. If a positive determination is made in block 94, the logical flow may proceed to block 96 where an invitation to become a friend (or fan) of the network owner is transmitted to the electronic device 10. The invitation may be received in block 98 and, if the user of the electronic device 10 desires, steps may be taken with the electronic device 10 to become a friend (or fan) of the network owner.

As will be appreciated, the use of social media status of a user of an electronic device 10 to provide network access to a network 18 that requires access credentials may have advantage in a number of circumstances. Advantages include limiting the sharing of access credentials directly with the user of the electronic device 10, and making network access easy and transparent for the user of the electronic device.

In one exemplary situation, an individual may have established a wireless network 18 using a WiFi router as an access point 26 in his or her home. That individual may invite family and/or friends to the home for a social gathering, such as watching a sporting event on television. Assuming that the persons coming to the home for the social gathering are family members and/or friend members of a selected access permission level 74, then when those persons arrive at the home, their corresponding electronic devices 10 may be able to use the network 18 for wireless communications.

In effect, the owner of the network 18 has imbued access to the communications capabilities of network 18 with sharable properties that are useable by others that fall within a permitted access group, similar to the way one might share a picture on a social network website with others that fall within a permitted access group for seeing pictures on the owner's portion of the social network website. In this manner, the network owner may control the persons that are allowed to share in communications capabilities of the network 18. Also, the persons sharing in the communications capabilities avoid going through the normal access protocol for the network 18, which would typically involve using the user interface 44 of the electronic device 10 to enter access credentials.

In another exemplary situation, the owner of a coffee shop, or a chain of restaurants, may install a network 18 and select a permission access level 74 that permits friend members and acquaintances to access the network 18. In this manner, the network owner will allow electronic devices 10 belonging to social network friends and many of the people that accompany the social network friends to the establishment to use the network 18 for wireless communications.

In another exemplary situation, a group of network owners may form a cooperative. Each network owner, and those authorized to use each individual network, may be members of a selected access permission level for all of the networks in the cooperative. In this manner, as long as a member of the access permission level is in communication range of one of the networks in the cooperative, the member will have network access for wireless communications. In effect, the network owners established network access over a geographic area that is larger than any of the individual networks that form part of the cooperative.

Although certain embodiments have been shown and described, it is understood that equivalents and modifications falling within the scope of the appended claims will occur to others who are skilled in the art upon the reading and understanding of this specification.

What is claimed is:

1. A method of providing access to a secure network for wireless communications, the network requiring access credentials to carry out the wireless communications, comprising:
registering the network and the access credentials for the network with a network access management system;
configuring network access settings including an access permission level that includes persons designated or accepted as social network friends of an owner of the network; and
securely providing the access credentials to an electronic device associated with a social network friend when the electronic device is in communication range of the network.

2. The method of claim 1, wherein the electronic device has access to a network separate from the network for which access credentials is required at the time that the electronic device is in communication range of the network.

3. The method of claim 2, wherein the separate network is a cellular network to which the electronic device has subscription access.

4. The method of claim 2, wherein the providing of the access credentials to the electronic device is carried out via the separate network.

5. The method of claim 1, wherein the social network friend is identified by an identifier for the electronic device in the network access management system.

6. The method of claim 1, wherein the access credentials are provided to the electronic device in response to a request for network connectivity by the electronic device.

7. The method of claim 1, wherein there are plural access permission levels, each with a different combination of member electronic devices, and one of the plural access permission levels is selected by an operator of the network for sharing of access to the network with the corresponding members of the selected access permission level.

8. The method of claim 7, wherein the access permission levels include a level with social network friends of the network owner and family members of the network owner.

9. The method of claim 7, wherein the access permission levels include a level with social network friends of the network owner and social network acquaintances of the network owner, the social network acquaintances of the network owner being social network friends of the social network friends of the network owner.

10. The method of claim 1, wherein the social network friends of the access permission level have enrolled as social network fans of an owner of the network.

11. The method of claim 1, wherein if an electronic device that requests network connectivity is not a social network friend of the network owner, then inviting a user of the electronic device to become a social network friend of the network owner.

12. The method of claim 1, wherein the social network friends of the access permission level are persons identified as social network friends of the network owner in a commercially available computerized social network service.

13. A network access management system for providing access to a secure network for wireless communications, the network requiring access credentials to carry out the wireless communications, comprising a processing circuit configured to execute logical instructions that:
register the network and the access credentials for the network;
configure network access settings including an access permission level that includes persons designated or accepted as social network friends of an owner of the network; and
securely provide the access credentials to an electronic device associated with a social network friend when the electronic device is in communication range of the network.

14. The system of claim 13, wherein the electronic device has access to a network separate from the network for which access credentials is required at the time that the electronic device is in communication range of the network.

15. The system of claim 14, wherein the separate network is a cellular network to which the electronic device has subscription access.

16. The system of claim 14, wherein the providing of the access credentials to the electronic device is carried out via the separate network.

17. The system of claim 13, wherein the social network friend is identified by an identifier for the electronic device in the network access management system.

18. The method of claim 13, wherein the access credentials are provided to the electronic device in response to a request for network connectivity by the electronic device.

19. The method of claim 13, wherein there are plural access permission levels, each with a different combination of member electronic devices, and one of the plural access permission levels is selected by an operator of the network for sharing of access to the network with the corresponding members of the selected access permission level.

20. The method of claim 19, wherein the access permission levels include a level with social network friends of the network owner and family members of the network owner.

21. The method of claim 19, wherein the access permission levels include a level with social network friends of the network owner and social network acquaintances of the network owner, the social network acquaintances of the network owner being social network friends of the social network friends of the network owner.

22. The method of claim 13, wherein the social network friends of the access permission level have enrolled as social network fans of an owner of the network.

23. The method of claim 13, wherein if an electronic device that requests network connectivity is not a social network friend of the network owner, then the network access management system invites a user of the electronic device to become a social network friend of the network owner.

24. The method of claim 13, wherein the social network friends of the access permission level are persons identified as social network friends of the network owner in a commercially available computerized social network service.

25. A method of acquiring access to a secure network for wireless communications by an electronic device, the network requiring access credentials to carry out the wireless communications, comprising:
establishing a social network friend status with an owner of the network as a prerequisite for receiving the access credentials for the network;
detecting an access point belonging to the network;
requesting network connectivity to the network from a network access management system;
electronically and securely receiving the access credentials from the network access management system;
connecting to the access point for carrying out wireless communications with the electronic device; and
maintaining the access credentials in a secure manner by the electronic device so that a user of the electronic device is without an ability to display or ascertain the access credentials.

26. The method of claim 25, wherein the electronic device has access to a network separate from the network for which access credentials is required at the time that the electronic device is in communication range of the network.

27. The method of claim 26, wherein the separate network is a cellular network to which the electronic device has subscription access.

28. The method of claim 26, wherein the receiving of the access credentials by the electronic device is carried out via the separate network.

29. The method of claim 25, wherein the social network friend status is established by enrolling as a social network fan of an owner of the network.

30. The method of claim 25, wherein the social network friend status is established by becoming a social network friend of the network owner in a commercially available computerized social network service.

31. An electronic device that is established as a social network friend with an owner of a secure network as a prerequisite for receiving access credentials for the network, the access credentials required in order for the electronic device to carry out wireless communications using the network, the electronic device comprising:
a radio circuit for establishing a network connection with the network and carry out the wireless communications; and
a control circuit configured to acquire to the access credentials by executing logical instructions that:
detect an access point belonging to the network;
request network connectivity with the network from a network access management system;
electronically and securely receive the access credentials from the network access management system;
connect to the access point for carrying out the wireless communications;
and
maintain the access credentials in a secure manner by the electronic device so that a user of the electronic device is without an ability to display or ascertain the access credentials.

32. The electronic device of claim 31, wherein the electronic device has access to a network separate from the network for which access credentials is required at the time that the electronic device is in communication range of the network.

33. The electronic device of claim 32, wherein the separate network is a cellular network to which the electronic device has subscription access.

34. The electronic device of claim 32, wherein receipt of the access credentials by the electronic device is carried out via the separate network.

35. The electronic device of claim 31, wherein the social network friend status is established by enrolling as a social network fan of an owner of the network.

36. The electronic device of claim 31, wherein the social network friend status is established by becoming a social network friend of the network owner in a commercially available computerized social network service.
